(19) United States
(12) Patent Application Publication
(10) Pub. No.: US 2014/0246421 A1
(43) Pub. Date: Sep. 4, 2014

(54) ADAPTIVE HEATING SYSTEM USING BOTH AC AND DC POWER

(71) Applicant: MING-YI CHAO, Taipei Hsien (TW)

(72) Inventor: MING-YI CHAO, Taipei Hsien (TW)

(21) Appl. No.: 13/784,780

(22) Filed: Mar. 4, 2013

(51) Int. Cl. H05B 3/02

(52) U.S. Cl. CPC H05B 3/02
USPC 219/475

(57) ABSTRACT

An adaptive heating system using both AC and DC power includes an AC and DC switching device connected to an AC source and at least one DC source; a device to be heated having an AC heating device and at least one DC heating device and a detector for detecting at least one state therein; the AC heating device being connected to the AC source and the DC heating device being connected the DC source; and a controller connected to the AC and DC switching device and the detector for receiving signals from the detector and for adjusting outputs of the AC and DC switching device based on detection results from the detector. The AC source is used in high power consumption state and the DC source is used in lower power consumption state. When power consumption is very high, both AC source and the DC source are used simultaneously.

### FIELD OF THE INVENTION

The present invention relates to electric heating control, and in particular to an adaptive heating system using both AC and DC power.

### BACKGROUND OF THE INVENTION

Conventionally, AC power source is used in heating of a larger amount of water. This is because the AC power source can provide a larger power sufficiently and efficiently in heating, while DC power sources are lower power devices, which heat slowly and thus is impractical in use. Even, the DC power is too small to heat the water because the power dissipation from the water to be heated is larger than the power supplied from the DC power source. As a result, the water cannot be heated.

However, AC power is high cost and it is possible that the electricity leakage occurs. Therefore, this kind of devices needs good electric insulation which will worsen the heat ability. Furthermore, the cost is increased.

Many current used temperature heating or control devices have above mentioned problem, and furthermore, if using AC power in temperature preservation, the cost is high and it is not beneficial in low power consumption usages.

### SUMMARY OF THE INVENTION

Therefore, to resolve the above mentioned prior art defects, the present invention provides an adaptive heating system using both AC and DC power which heats a device to be heated by using AC or DC power at different stages based on the requirements of heating conditions. As a repaid heating is needed, AC power source is used, and when the heating process is slow, DC source is used. The DC source is low cost, high power efficient and safe, but it is difficult to provide large power in a short time period. Thus the present invention provides a way which have the advantages of AC and DC sources.

To achieve above object, the present invention provides an adaptive heating system using both AC and DC power comprises an AC and DC switching device connected to an AC source and at least one DC source for switching between the AC source and the DC source as an output power source; a device to be heated having an AC heating device and at least one DC heating device and a detector for detecting at least one state therein; the AC heating device being connected to the AC source and the DC heating device being connected the DC source; and a controller connected to the AC and DC switching device and the detector for receiving signals from the detector and for adjusting outputs of the AC and DC switching device based on detection results from the detector; the controller having a logic circuit for determining outputs of the AC and DC switching device. The AC source serves to provide power as the device to be heated needs larger power and the DC source serves to provide power as the device to be heated needs smaller power. The AC source and the DC source are used simultaneously when power consumption is very high.

### BRIEF DESCRIPTION OF THE DRAWINGS:

FIG. 1 shows the structure of the present invention.

FIG. 2 shows the first operation mode of the present invention.

FIG. 3 shows the second operation mode of the present invention.

FIG. 4 shows the third operation mode of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

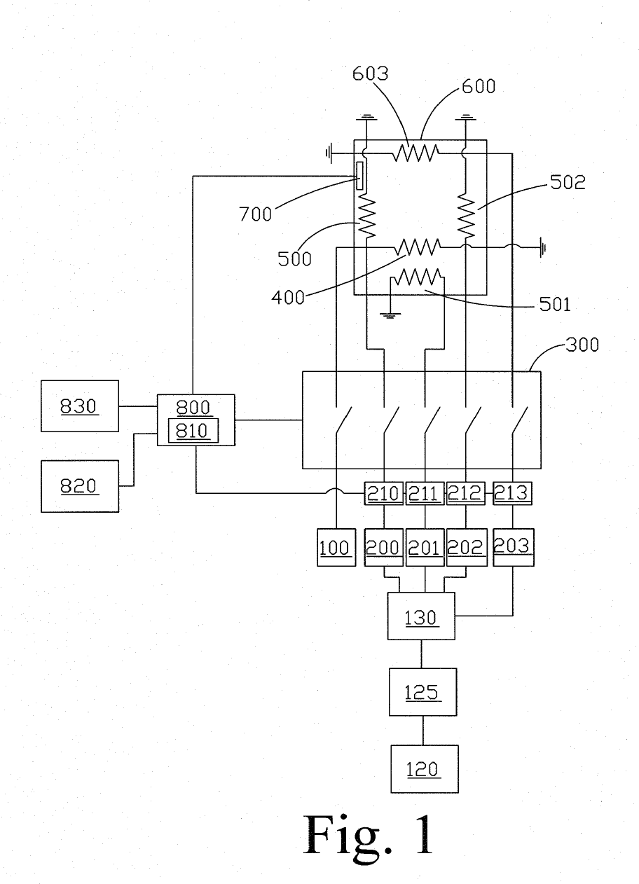

With reference to FIG. 1, an adaptive heating system using both AC and DC power of the present invention is illustrated. The present invention includes the following elements.

An AC (Alternative current) source 100 is from an external power source. For example, the AC source may have a voltage of 100 Volts with a power of 2500 Watts.

At least one DC source 200 is included.

An AC and DC switching device 300 has input ends connected to the AC source 100 and the at least one DC source 200 for switching between the AC source 100 and the DC source 200.

An AC heating device 400 is connected to an output end of the AC and DC switching device 300 for receiving the current from the AC source 100 and the AC and DC switching device 300 and then converting the current into heat for heating.

At least one DC heating device 500 is included. Each DC heating device 500 has a correspondent DC source 200. Each DC heating device 500 is connected to an output end of the AC and DC switching device 300 for receiving current from a respective one of the DC source 200 and the AC and DC switching device 300 and then converting the current into heat for heating.

The AC heating device 400 and the DC heating device 500 are installed in the device to be heated 600. Preferably, the device to be heated 600 is one of a water boxes, air conditioners, and heating carpets.

Preferably, as illustrated in FIG. 1, there are multiple DC sources, in this embodiment, four DC sources 200, 201, 202 and 203 are shown. However, this embodiment is not used to confine the scope of the present invention. Each one of the DC sources 200, 201, 202 and 203 has a correspondent DC heating devices 500, 501, 502 and 503. All the DC heating devices are arranged at a periphery of the device to be heated 600 with approximately equal space. In this embodiment, two adjacent devices to be heated are spaced with an angle difference of 90 degrees, so that the four DC heating devices 500, 501, 502 and 503 are distributed uniformly at the periphery of the device to be heated 600 and thus the heating work is performed uniformly.

In this embodiment, the four DC sources 200, 201, 202 and 203 are provided by a same AC power source 120 which are converted by an AC to DC converter and then are voltage reduction by a voltage reduction device 130. Preferably, the DC source is a current source of 12 volts with a power of 120 Watts.

With reference to FIG. 1, the present invention further includes.

A detector 700 is for detecting at least one states of the device to be heated 600. In this embodiment, the detector is a thermometer 700 for detecting temperatures in the device to be heated 600.

A controller 80 is connected to the AC and DC switching, device 300 and the detector 700. The controller 80 receives signals from the detector 700 and adjusts outputs of the AC and DC switching device based on detection result from the detector. In this embodiment, the controller 80 serves to control temperatures of the device to be heated 600. The controller 800 has a logic circuit 810 for determining selections of the AC and DC switching device 300, such as to select to output current from the AC source 100 or from the at least one DC source 200.

The controller 80 may be connected to a display 820 for displaying related information, such as water temperature, power source used, etc. Besides, the controller 80 can also be connected to an alarm device 830 for emitting alarms about the device to be heated 600.

The power source of the controller 80 may be one of the AC source 100 or the DC source 200 the voltage of which can be reduced properly. However, this is known in the prior art and thus the details will not be described herein.

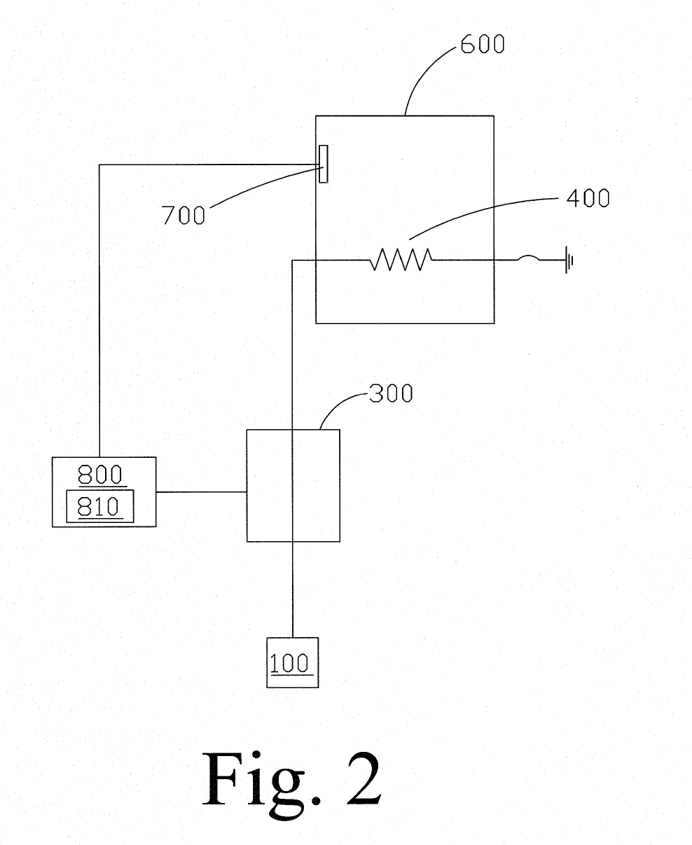

With reference to FIG. 2, one operation mode of the present invention is illustrated. When water temperature of the device to be heated 600 is much lower than a preset temperature to be achieved, at initial heating stage, a higher power is needed to heat the device to be heated 600 and thus initially, the AC and DC switching device 300 selects the AC source 100 as the power supply for providing power to the AC heating device 400 to heat the device to be heated 600. Thus, the system of the present invention provides a higher efficiency to heat the device to be heated 600.

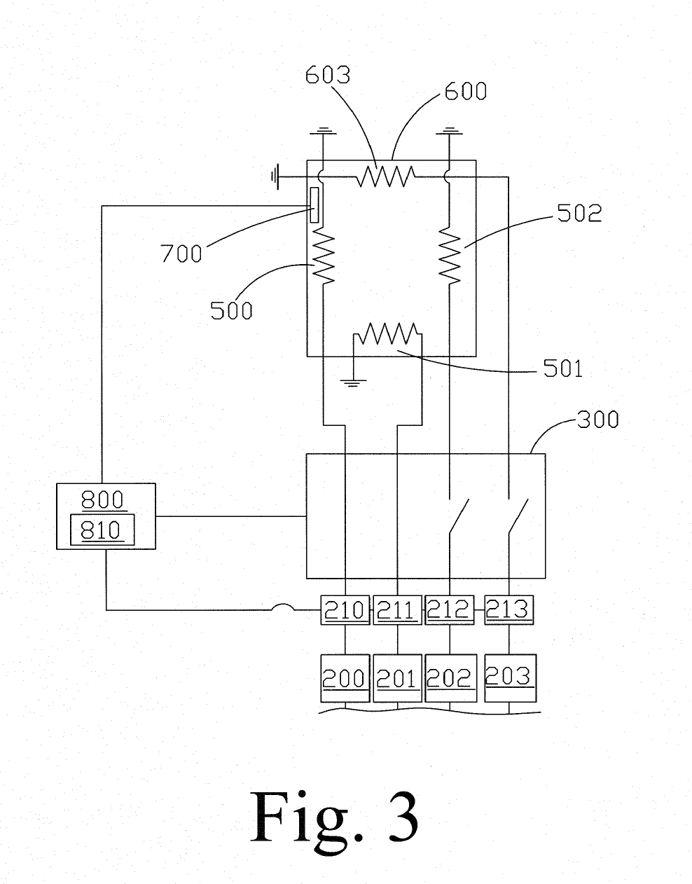

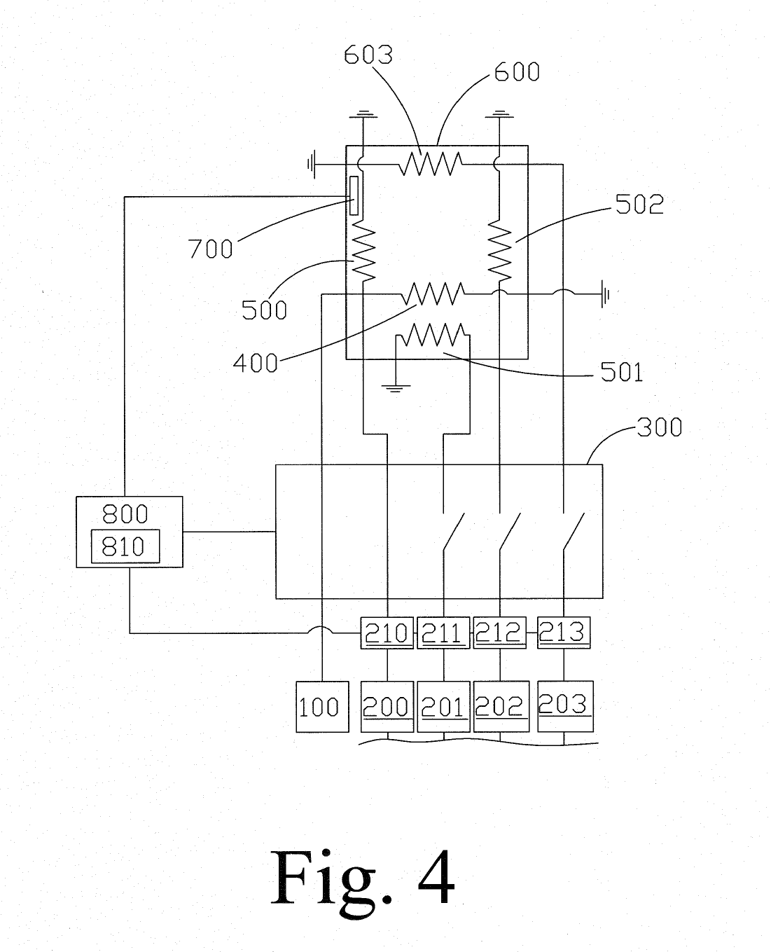

With reference to FIG. 3, the second operation mode of the present invention is illustrated. When the temperature of the device to be heated 600 has achieved to a set value, then the AC and DC switching device 300 selects at least one of the DC sources 200 as the power output devices so that the system of the present invention provides DC power to the device to heat the device to be heated 600. When the AC and DC switching device 300 selects the DC sources 200 as power output device, at least one of the DC heating devices 500, 501, 502 and 503 will actuate to heat the device to be heated 600 or keep warming to the device to be heated 600. In FIG. 4, it is illustrated that two DC sources 200, 201 are actuated for heating.

Referring to FIG. 4, the third operation mode of the present invention is illustrated. When a very larger power is needed to provide to the device to be heated 600, the system of the present invention can actuate the AC source 100 and DC sources 200 at the same time so that the AC source 100 and the DC sources 200, 201, 202 and 203 are actuated to heat the device to be heated 600.

Furthermore, in the present invention, the controller 800 can be set with various operation ways, such as boiling water, evaporation, bathing foot, body bath, etc. Each operation way provides different operation temperatures and operation conditions. When a user inputs a desire operation way, the logic circuit will calculate the operation conditions and then the selects desired operation modes based on the operation conditions. The device to be heated 600 can be set with various operation modes and various operation ways.

With reference to FIG. 1, in the present invention, an output end of each DC source 200, 201, 202 and 203 can be installed with a respective load adjuster 210, 211, 212 and 213. Each load adjuster is connected to the controller 800 and is controlled by the controller 800 for controlling the output power of the DC source 200. The logics of the load adjuster can be set in the logic circuit 810 of the controller 800 so that the load adjustment can be set based on the operation modes and the operation ways.

It should be noted in the present invention, the device to be heated 600 cannot be confined to be a water heating device. All objects for electric heating are within the scope of the present invention, such as air condition, drying, evaporation, dry heating, wet heating, etc. All these are within the scope of the present invention.

The object of the present invention is to provide a temperature control device. Both of the AC source and DC sources are used to the device to be heated, which are actuated at different operation modes based on the operation ways. AC power will induce power leakage and thus is dangerous to human, while DC power is safe and does not induce

The advantages of AC source and DC source are used for heating at different stages based on the requirement of heating conditions. As a repaid heating is needed, AC power source is used, and when the heating process is slow, DC source is used. The DC source is low cost, high power efficient and safe, but it is difficult to provide large power in a short time period. Thus the present invention provides a way which has the advantages of AC and DC sources.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An adaptive heating system using both AC and DC power, comprising:
an AC (Alternative current) source ;
at least one DC source;
an AC and DC switching device connected to the AC source and at least one DC source for switching between the AC source and the DC source as an output power source;
a device to be heated having an AC heating device, and at least one DC heating device and a detector for detecting at least one state therein;
the AC heating device being connected to the AC source and the DC heating device being connected the DC source; and
a controller connected to the AC and DC switching device and the detector; the controller receiving signals from the detector and adjusting outputs of the AC and DC switching device based on detection results from the detector; the controller having a logic circuit for determining selection of outputs of the AC and DC switching device; and
wherein the AC source serves to provide power as the device to be heated needs larger power in short time period and the DC source serves to provide power as the device to be heated needs smaller power; and
wherein the AC source and the DC source are used simultaneously when power consumption is very high.

2. The adaptive heating system using both AC and DC power as claimed in claim 1, wherein
when water temperature of the device to be heated is much lower than a preset temperature to be achieved, the AC and DC switching device selects the AC source as the power supply; so that the AC source providing power to the AC heating device to heat the device to be heated;
when the temperature of the device to be heated has achieved to a set value, the AC and DC switching device selects at least one of the DC sources as the power output devices so that the system provides DC power to the device to heat the device to be heated; and
when a very larger power is needed to provide to the device to be heated, the system can actuate the AC source and DC sources at the same time so that the AC source and the DC sources are actuated to heat the device to be heated.

3. The adaptive heating system using both AC and DC power as claimed in claim 1, wherein the operation way is one of air conditioning, drying, evaporation, dry evaporation, wet evaporation, or the combination thereof.

5. The adaptive heating system using both AC and DC power as claimed in claim 1, wherein there are a plurality of DC heating devices, which are arranged along a periphery of the device to be heated.

6. The adaptive heating system using both AC and DC power as claimed in claim 5, wherein the plurality of DC heating devices are spaced with an approximately equal angle.

7. The adaptive heating system using both AC and DC power as claimed in claim 1, wherein the at least one DC source is provided by a power source which is converted by an AC to DC converter and then is voltage reduction by a voltage reduction device.

8. The adaptive heating system using both AC and DC power as claimed in claim 1, wherein the controller is connected to a display device for displaying related messages.

9. The adaptive heating system using both AC and DC power as claimed in claim 1, wherein the controller is connected to an alarm device for alerting conditions of the device to be heated.

10. The adaptive heating system using both AC and DC power as claimed in claim 1, wherein an output end of at least one DC source is installed with a Toad adjuster for adjusting output power of the DC source; the load adjuster is adjusted by the controller.

11. The adaptive heating system using both AC and DC power as claimed in claim 1, wherein the device to be heated is one of a water box, an air conditioner, and an electric carpet.
